(19) United States
(12) Patent Application Publication
(10) Pub. No.: US 2013/0083537 A1
(43) Pub. Date: Apr. 4, 2013

(54) ACOUSTICALLY TRANSPARENT LUMINAIRE LENS FOR MEDIA ASSEMBLIES

(71) Applicant: Ronald Paul Harwood, West Bloomfield, MI (US)

(72) Inventor: Ronald Paul Harwood, West Bloomfield, MI (US)

(21) Appl. No.: 13/644,789

(22) Filed: Oct. 4, 2012

Related U.S. Application Data
(60) Provisional application No. 61/543,039, filed on Oct. 4, 2011.
(60) Provisional application No. 61/543,041, filed on Oct. 4, 2011.

(51) Int. Cl. F21V 5/04; F21V 33/00

(52) U.S. Cl. 362/253

(57) ABSTRACT

A media assembly is provided with a housing having an opening. A light source is oriented in the housing for conveying light from the opening. A speaker assembly is oriented in the housing for conveying acoustic vibrations from the opening. A lens covers the opening. The lens has a plurality of openings for permitting light and acoustic vibrations to pass therethrough.

### CROSS-REFERENCE TO RELATED APPLICATIONS

This application claims the benefit of U.S. provisional Application No. 61/543,039 filed Oct. 4, 2011, and U.S. provisional Application No. 61/543,041 filed Oct. 4, 2011, the disclosures of which are incorporated in their entirety by reference herein.

### TECHNICAL FIELD

Various embodiments relate to an acoustically transparent luminaire lens for media assemblies.

### BRIEF DESCRIPTION OF THE DRAWINGS

FIG. 1 is a perspective view of a media assembly according to an embodiment;

FIG. 2 is a partially exploded elevation view of the media assembly of FIG. 1;

FIG. 3 is another perspective view of the media assembly of FIG. 1, illustrated with a lens removed;

FIG. 4 is a side elevation view of a speaker and a reflector and diffuser apparatus of the media assembly of FIG. 1;

FIG. 5 is another side elevation view of the reflector and diffuser apparatus of FIG. 4;

FIG. 6 is a top plan view of the reflector and diffuser apparatus of FIG. 4;

FIG. 7 is a perspective view of the lens from the media assembly of FIG. 1; and

FIG. 8 is a partial section view of the lens of FIG. 7.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

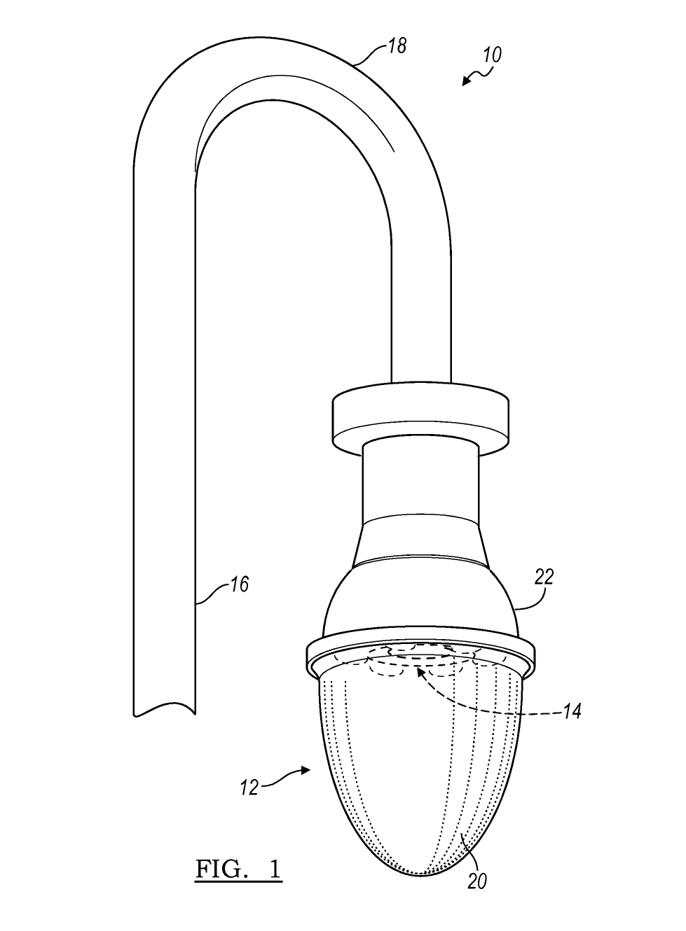

Referring now to FIG. 1, a media assembly is illustrated according to at least one embodiment and is referenced generally by numeral 10. The media assembly 10 includes a combination of a luminaire 12 and a speaker assembly 14. The luminaire 12 and the speaker assembly 14 are illustrated mounted upon a structural pole 16 for supporting the luminaire 12 and the speaker assembly 14 upon an underlying support surface and for elevating the luminaire 12 and the speaker assembly 14 above the underlying support surface. Although the media assembly 10 is illustrated mounted to the structural pole 16, the invention contemplates various structural supports for the media assembly, including street poles, light poles, sign poles, direct surface mounting, pendant lighting, catenary lighting, or the like. For the depicted embodiment, the structural pole 16 has a curved arm 18 for suspending the media assembly 10. Unlike media assemblies that are mounted directly atop of a straight pole for conveying light and/or sound outward, the suspended media assembly 10 conveys light and sound downward as well as outward.

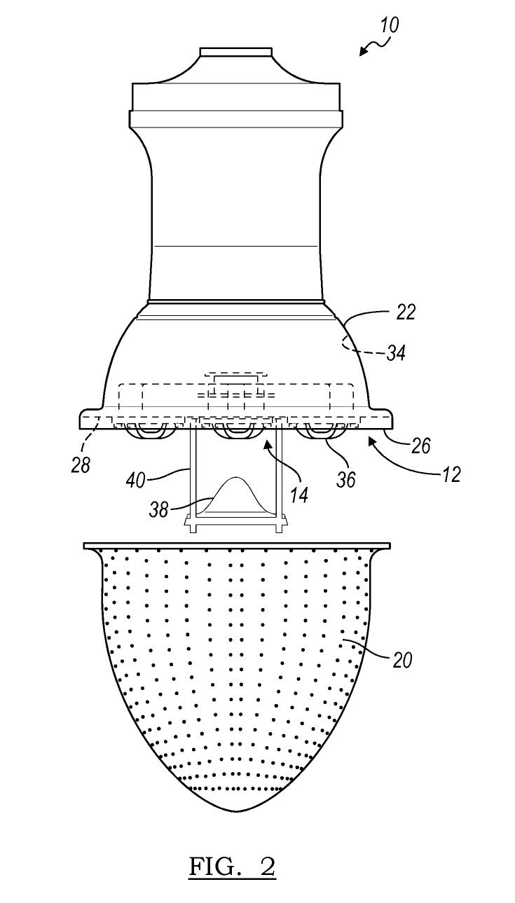

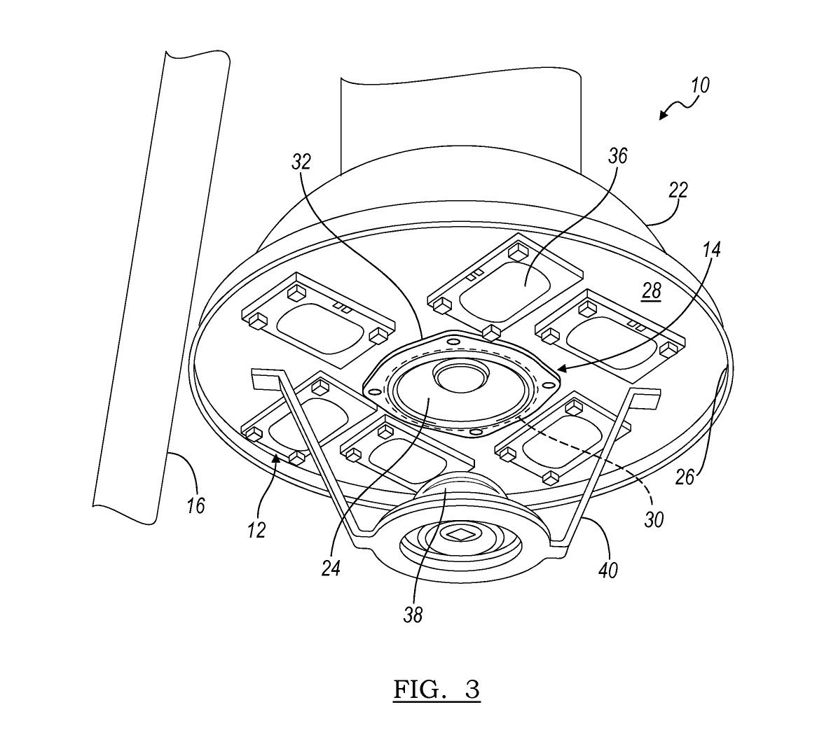

Referring now to FIGS. 2 and 3, the media assembly 10 is illustrated with a lens 20 removed. The media assembly 10 includes a housing 22 for housing a downward-facing speaker 24. The housing 22 has an opening 26, which is enclosed by a substrate 28. The substrate 28 has a central opening 30 for seating a mounting flange 32 of the speaker 24. The substrate 28 also encloses the housing 22 for providing a resonating chamber 34 for the speaker 24. The substrate 28 is also utilized for mounting the luminaire 12 to the housing 22. In at least one embodiment, the luminaire 12 is provided by a plurality of light emitting diode (LED) arrays 36. Prior art speaker assemblies that focus a single speaker directly downward provide an uneven range of coverage. A reflector 38 is provided for evenly reflecting acoustic vibrations outward from the housing 22.

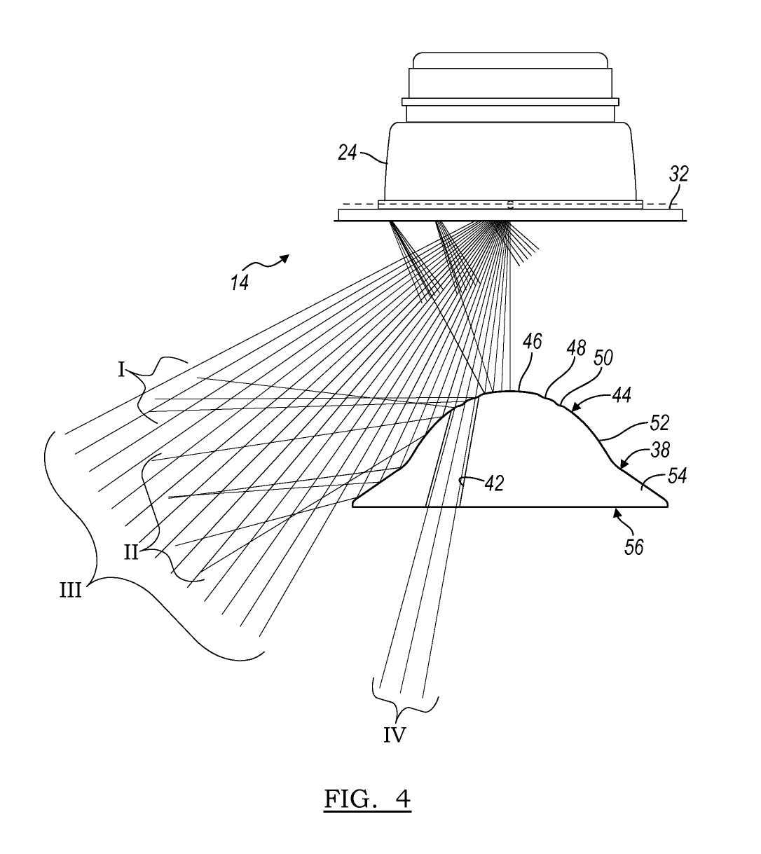

A pair of support arms 40 extends from the substrate 28 and supports the reflector 38 beneath the speaker 24. FIG. 4 illustrates a distribution pattern for acoustic sound waves that are generated by the speaker 24. The distribution pattern includes reflected sound waves of various frequencies labeled as group I. The distribution pattern also includes reflected sound waves of a high frequency labeled as group II. The reflected sound waves of groups I and II are reflected from the reflector 38. The distribution pattern includes directly transmitted sound waves of various frequencies labeled as group III. High frequency directly transmitted sound waves are labeled as group IV. The directly transmitted sound waves of groups III and IV are not reflected from the reflector 38. The reflector 38 includes a plurality of apertures 42 formed therethrough for permitting the acoustic vibrations labeled as group IV to pass through the reflector 38. Thus, the reflector 38 also operates as a diffuser.

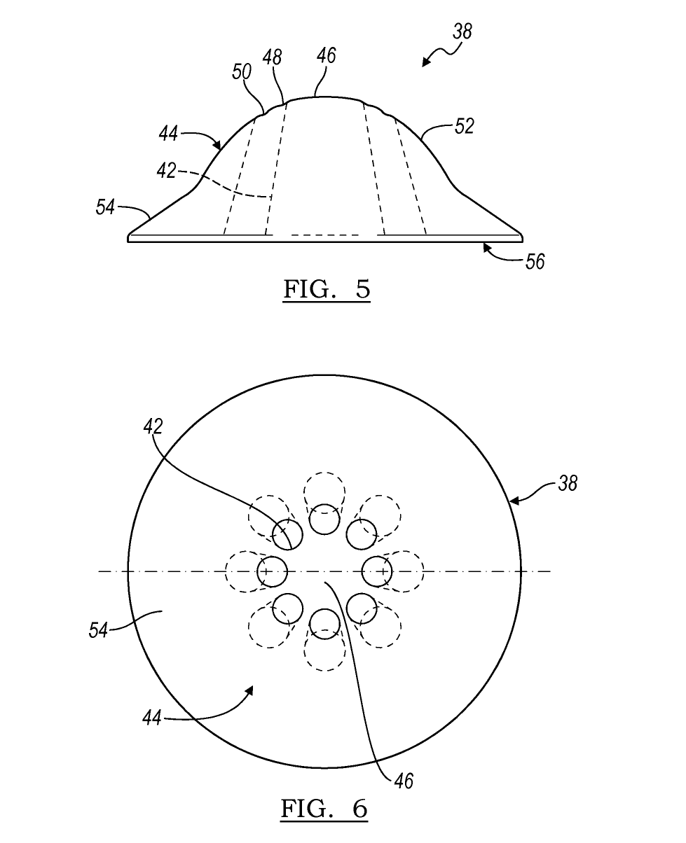

FIGS. 4-6 illustrate the reflector 38 in greater detail. The reflector 38 includes a central dome 44. The dome 44 has a peak 46, which is bounded by a pair of coaxial annular recesses 48, 50. The peak 46 is employed for reflecting pressure and low frequency vibrations from the speaker 24 back to the speaker 24 for acoustically tuning the speaker 24, amplifying movement of the speaker 24, and minimizing the size of the associated resonating chamber 34. For example, the peak 46 is sized to enhance vibrations of frequencies within the range of 20 Hz to 1,500 Hz towards the speaker 24.

The annular recesses 48, 50 are employed for directing incidental sound waves in this region radially outward from the peak 46. Thus, the annular recesses 48, 50 provide a perimeter for the reflective surface of the peak 46. Midrange to high frequency vibrations reflect off the annular recesses 48, 50 and out of the speaker assembly 14. The annular recesses 48, 50 are contoured to direct the midrange to high frequency vibrations such that these frequencies avoid the speaker 24. The midrange and high frequency vibrations are in the range of 1,500 Hz to 20 kHz. Some of the low frequency vibrations also reflect off the peak 46 and out of the speaker assembly 14. Therefore, some of the low frequency vibrations are reflected into the speaker 24; while reflection of midrange to high frequencies into the speaker 24 is eliminated. The speaker 24 produces frequencies that are full range. Low frequency vibrations are enhanced by the peak 46 of the reflector 38, while all frequencies are affected and all frequencies have enhanced distribution due to the reflector 38.

Direct application of a cone speaker results in uneven sound distribution. In order to optimize efficiency for all frequencies, the dome 44 extends toward the speaker 24 to provide uniform distribution of the frequencies out of the speaker assembly 14. Additionally, the low frequencies are reflected back to the speaker 24. Air that is moved by the speaker 24 is reflected off the peak 46 of the dome 44 and back to the speaker 24. The reflected frequencies and air pressure amplify the back pressure of the speaker 24, thereby tuning the speaker 24. Additionally, by amplifying the back pressure of the speaker 24, a smaller resonating chamber 34 is permitted in comparison to resonating chambers that are sized for a speaker that does not have amplified back pressure. By reducing the size of the resonating chamber 34, the size of the housing 22 is also reduced thereby minimizing the packaging required for concealing the speaker 24 and avoiding any drawback to the appearance of the overall luminaire 12 and the speaker assembly 14.

The dome 44 is generally hemispherical-shaped. The peak 46 has a radius (2.25 inches, for example) greater than a height (1.84 inches, for example) of the reflector 38. An outboard region 52 of the dome 44 is utilized for reflecting sound waves away from the reflector, such as the low frequency sound waves of group II illustrated in FIGS. 3 and 4. The outboard region 52 may also have a radius (2.20 inches, for example) that is greater than the height of the reflector 38 and is offset from the center of the reflector 38. Overall, the dome 44 is generally convex for reflecting pressure back to the speaker 24 and reflecting sound waves radially outward from the reflector 38.

The reflector 38 also includes a circumferential flange 54 extending radially outward from the dome 44. The flange 54 has a generally flat acoustically reflective surface for reflecting the high frequency sound waves of group II. The flange 54 is provided about the perimeter of the dome 44. The flange 54 and apertures 42 balance a distribution of the high frequency sound waves directed beneath the media assembly 10 and reflected away from the reflector 38. The apertures 42 permit the high frequency sound waves of group IV to pass through the reflector 38 to be conveyed to an underlying support surface. Thus, the flange 54 and apertures 42 permit a balanced distribution of sound waves beneath the media assembly 10 and away from the base of the pole 16.

Referring again to FIG. 4, empirical testing for a five inch diameter cone speaker has found ratios for tuning the relationship of the reflector 38 and the speaker 24. For example, a suitable ratio of an overall diameter of an acoustic reflective surface of the reflector to a diameter of the speaker is approximately 1.5 to 1. This relationship is scalable for cone speakers 24 of varying diameters. A suitable ratio of an overall diameter of the acoustic reflective surface of the reflector to a diameter of the central region is approximately 1.4 to 1. A suitable ratio of a diameter of an acoustic reflective surface of the reflector to a distance between the speaker and a peak of the central region of the reflector is approximately 2.2 to 1. Likewise a suitable ratio of a diameter of the speaker to the distance between the speaker and a peak of the central region of the reflector is approximately 1.4 to 1. These ratios may be scaled for speakers 24 to varying diameters.

With reference again to FIGS. 4-6, the apertures 42 are illustrated in greater detail. According to an embodiment, the apertures 42 extend in a radial array about a central nadir below the speaker 24. Each aperture 42 is tapered to avoid internal reflections within the aperture. Although the radial array of eight apertures 42 is illustrated, the invention contemplates any number of apertures 42. Each aperture is offset from center 0.70 inches on the dome 44 and angled to be offset from center 1.07 inches on a bottom surface 56 of the reflector 38. The angle is approximately seventy-eight degrees from the bottom surface 56 to the centerline of the aperture 42. Each aperture 42 enlarges and diameter from the dome 44 to the bottom surface 56 thereby creating an angle of the aperture 42 sidewall that is three degrees from the respective centerline.

The apertures 42 act as sound tubes and permit acoustic vibrations to fill an area directly beneath the media assembly 10. The reflector 38 is generally aligned with the centerline of the speaker 24 and permit sound to pass therethrough, thereby providing a dead zone directly beneath the media assembly 10 the apertures 42 do not have any beveling or chamfering that may otherwise reflect sound.

Jack screws or other adjustment mechanisms may be provided between the reflector 38 and the support arms 40, or between the support arms 40 and the substrate 28 for tuning the reflector 38 call to the speaker 24. The reflector 38 and the support arms 40 may be formed separately or integrally. The reflector 30 a.m. support arms 40 may be generally translucent, such as by being formed from acrylic material to reflect acoustic vibrations while refracting light.

With reference again to FIGS. 1 and 2, the media assembly 10 provides a speaker assembly 14 with a concealed speaker 24 that is directed downward. Since the speaker 24 is directed downward, it is not exposed to the external environment and avoids collection of precipitation or external debris. By providing the speaker 24 coaxial to the reflector 38, a symmetrical appearance is provided that is not obfuscated by an off-center speaker assembly. Additionally, the media assembly 10 provides the appearance of a conventional incandescent luminaire, thereby inconspicuously presenting modern and new technologies with an appearance of conventional technologies. In other words, improved lighting and sound are presented without drawing attention away from the underlying thoroughfare.

Prior art incandescent illumination radiates omnidirectionally. However LEDs, such as the arrays 36, provide focused illumination form each of the specific point sources. The LED arrays depicted in FIG. 3 are oriented around the speaker 24 in a quantity of six point sources, for example. In order to evenly distribute the light, the lens 20 in FIGS. 1 and 2 is employed to convey light through the lens 20, while also refracting the light. Additionally, the lens 20 is acoustically transparent for conveying the acoustic vibrations from the speaker 24 through the lens 20. By passing the light and the acoustic vibrations through the lens 20, the illumination and sound are overlapping a common region beneath the media assembly 10, including directly below and outward therefrom.

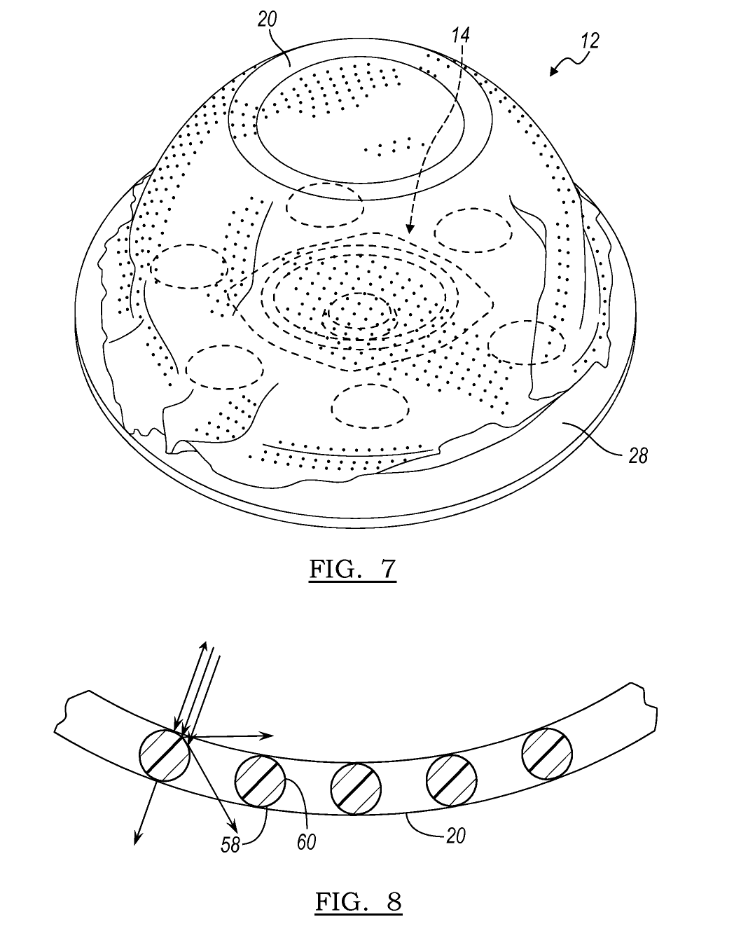

Referring now to FIG. 7, the lens 20 is porous or perforated to permit light and sound to pass. Concomitantly, the lens 20 diffuses light to avoid focused illumination. The lens 20 has a generally common thickness with a generally uniform porosity. The porosity may be greater than half, for example sixty percent, to promote acoustic transparency while minimizing internal reflection. The porosity also permits light to pass directly therethrough. The individual pore size may be small enough to prevent insects from ingress to the media assembly 10. Alternatively, the individual pore size may sufficiently large to permit insects to egress from the lens 20.

Various lens materials are contemplated within the spirit and scope of the embodiments of the invention. For example, a stamped stainless steel or aluminum sheet material or a stainless steel mesh may be employed. Alternatively, a fabric or woven material may be employed as depicted in FIG. 7. Either metallic or fabric embodiments provide a material that is subsequently coated with an epoxy or acrylic for refracting light through the coated material. Of course some rays may be blocked or reflected by the underlying metallic or fabric material. Yet the blocked rays illuminate thereby illuminating or glowing within the coated material for creating a visual effect similar to the glow of glass when illuminated from an enclosed incandescent light source. Empirical testing obtained extraordinary results for epoxy-impregnated, molded woven fabric as the example that is depicted in FIG. 7. Other suitable materials include a perforated glass material, a molded acrylic material, a drawn wire, a spun fiber, or the like. Also, the geometry may be woven, stamped, mesh, molded, cold-formed, drawn, spun or manufactured by any suitable method. The material may be at least partially translucent, and for some embodiments, may include an embedded opaque material for structural integrity.

FIG. 8 illustrates a suitable cross-section of the lens 20. The solid portion of the lens is represented by a plurality of generally rounded or cylindrical fibers 58. The fibers 58 prevent a uniformly flat surface that would otherwise reflect a large amount of light and sound. The fibers 58 present a line that is perpendicular to the approaching ray causing direct reflection, which is more advantageous than an entire flat surface. The rays traced in FIG. 8 represent light rays. Minimal reflection is directed back to the light source. The round surface permits reflected light to reflect outward from each fiber 58 and out of a pore 60 or into another fiber 58. Likewise, a large portion of the rays that intersect fibers 58 will illuminate the fiber 58 and refract through the fiber 58 and out to the thoroughfare.

The invention contemplates that the media assembly 10 may incorporate a variety of additional features beyond audio and lighting. For example, sensors may be employed to measure temperature, moisture, air quality, radiation, wind velocity and the like. Cameras may be utilized for surveillance or for live monitoring of the applicable thoroughfare. The media assembly 10 may also include receivers and/or transmitters, such as radio frequency or infrared, for analysis and/or on-site monitoring. Power and data interfaces or receptacles may be provided in the media assemblies for additional lighting (such as temporary or holiday lighting), signage, decorations, or the like. Each of these additional components may be oriented in the housings of the media assembly 10. The various features of the media assembly 10 may be controlled by the known techniques, such as those disclosed in Harwood U.S. Pat. No. 7,630,776 B2, the disclosure of which is incorporated by reference herein.

The media assembly 10 may be locally powered, self-powered (such as solar or wind powered), or may be powered from a central amplifier. The reflector 38 may be opaque or translucent for illumination. The reflector 38 may be molded from an acrylic or formed from another acoustically reflective material. The media assembly 10 may be utilized as an original installation, or may be utilized for retrofitting existing structural pole 16 for adding speaker assemblies 14. Moreover, efficient illumination from the LED arrays 36 minimizes power consumption. Likewise, by reflecting pressure to the speaker 24, a smaller speaker is required in comparison to prior art assemblies, thereby further minimizing power consumption and overall increasing the efficiency of the media assembly.

According to one embodiment, a speaker assembly is provided with a speaker, and a reflector spaced apart from and facing the speaker. The reflector has a central region, an outward region extending outward therefrom with a circumferential flange extending further outward from the central region for reflecting acoustic vibrations from the speaker radially outboard from the reflector. The reflector has a plurality of apertures formed therethrough for permitting acoustic vibrations to pass through the reflector.

According to a further embodiment of the speaker assembly, the central region is generally convex, and the speaker assembly further comprises a housing having a resonating chamber mounted to and in cooperation with the speaker such that pressure from the speaker is reflected from the central region to the speaker to amplify movement of the speaker and increase low frequency response.

According to an even further embodiment of the speaker assembly, the central region of the reflector is generally hemispherical with at least one annular recess formed therein for reflecting acoustic vibrations past and outboard from the reflector.

According to an even further embodiment of the speaker assembly, an acoustic reflective surface within a perimeter of the at least one annular recess, reflects the pressure back to the speaker.

According to a further embodiment of the speaker assembly, a housing is mounted to the speaker, and at least one support connects the housing and the reflector. The at least one support provides an opening between the supports for an outlet of the reflected acoustic vibrations.

According to an embodiment, a media assembly comprises a structural support, and the speaker assembly mounted upon the support.

According to a further embodiment of the media assembly, the speaker is directed towards an underlying support surface.

According to another further embodiment of the media assembly, the structural support further comprises a structural pole.

According to yet another further embodiment of the media assembly, the structural support is sized to orient the speaker assembly at a height above an average ear height.

According to an embodiment, a media assembly comprises a housing having an opening, a light source oriented in the housing for conveying light from the opening, a speaker assembly oriented in the housing for conveying acoustic vibrations from the opening, and a lens for covering the opening, the lens having a plurality of openings for permitting light and acoustic vibrations to pass therethrough.

According to a further embodiment of the media assembly, the lens is at least partially translucent.

According to another further embodiment of the media assembly, the lens is porous.

According to yet another further embodiment of the media assembly, the lens is formed from fibers.

According to yet another further embodiment of the media assembly, the lens does not have a continuous inner surface perpendicular to the light source for minimizing reflection within the lens.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A media assembly comprising:
a housing having an opening;
a light source oriented in the housing for conveying light from the opening;
a speaker assembly oriented in the housing for conveying acoustic vibrations from the opening; and
a lens for covering the opening, the lens having a plurality of openings for permitting light and acoustic vibrations to pass therethrough.

2. The media assembly of claim 1 wherein the lens is at least partially translucent.

3. The media assembly of claim 1 wherein the lens is porous.

4. The media assembly of claim 1 wherein the lens is formed from fibers.

5. The media assembly of claim 1 wherein the lens does not have a continuous inner surface perpendicular to the light source for minimizing reflection within the lens.

6. The media assembly of claim 1 wherein the lens is perforated.

7. The media assembly of claim 1 wherein the lens diffuses light to avoid focused illumination.

8. The media assembly of claim 1 wherein the lens has a generally common thickness with a generally uniform porosity.

9. The media assembly of claim 8 wherein the porosity is greater than half to promote acoustic transparency while minimizing internal reflection.

10. The media assembly of claim 1 wherein the lens is formed from a stamped stainless steel material.

11. The media assembly of claim 1 wherein the lens is formed from an aluminum sheet material.

12. The media assembly of claim 1 wherein the lens is formed from a stainless steel mesh.

13. The media assembly of claim 1 wherein the lens is formed from a fabric material.

14. The media assembly of claim 13 wherein the lens is coated with an epoxy or acrylic for refracting light.

15. The media assembly of claim 1 wherein the lens is formed from one of a perforated glass material, a molded acrylic material, a drawn wire, and a spun fiber.

16. The media assembly of claim 1 wherein the lens is manufactured from one of a woven material, a stamped material, a mesh material, a molded material, a cold-formed material, a drawn material, and a spun material.

17. The media assembly of claim 1 wherein the lens comprises an embedded opaque material for structural integrity.

18. The media assembly of claim 1 wherein the lens comprises a plurality of generally rounded fibers.

19. The media assembly of claim 1 further comprising a reflector spaced apart from and facing the speaker assembly, the reflector having a central region, an outward region extending outward therefrom with a circumferential flange extending further outward from the central region for reflecting acoustic vibrations from the speaker assembly radially outboard from the reflector, the reflector having a plurality of apertures formed therethrough for permitting acoustic vibrations to pass through the reflector.

20. The media assembly of claim 19 further comprising:
a housing mounted to the speaker assembly; and
at least one support connecting the housing and the reflector, the at least one support providing an opening between the supports for an outlet of the reflected acoustic vibrations.
